(19) United States
(12) Patent Application Publication
(10) Pub. No.: US 2012/0286197 A1
(43) Pub. Date: Nov. 15, 2012

(54) HOT TEST FLUID CONTAINING VAPOR PHASE INHIBITION

(75) Inventors: Jurgen P. De Kimpe, Gent (BE); Serge S. Lievens, Merelbeke (BE)

(73) Assignee: Chevron U.S.A. Inc., San Ramon, CA (US)

(21) Appl. No.: 13/293,879

(22) Filed: Nov. 10, 2011

Related U.S. Application Data
(63) Continuation-in-part of application No. 12/473,043, filed on May 27, 2009, now abandoned.
Application No. 12/473,043 is a continuation-in-part of application No. 12/428,249, filed on Apr. 22, 2009, now abandoned.
Application No. 12/428,249 is a continuation-in-part of application No. 12/428,270, filed on Apr. 22, 2009, now abandoned.

(51) Int. Cl. C09K 15/06; C09K 5/00

(52) U.S. Cl. 252/76; 252/389.3; 252/389.21

(57) ABSTRACT

This invention covers formulation providing protection against corrosion in both the liquid and vapor phase. Such formulations are used in applications where engine parts or fuel cell systems are subjected to a “running-in” or “hot test” prior to final assembly or storage. The invention includes a concentrate as well as a dilute solution. The synergistic combination of inorganic ammonium derivatives in combination with monocarboxylic or dicarboxylic acids and a silicate dramatically increases the period of protection for both ferrous and aluminum alloys. This enables storage for a longer period when the engine parts are shipped or stored prior to assembling.

### CROSS-REFERENCE TO RELATED APPLICATIONS

This application is a continuation-in-part of copending U.S. Pat. App. 12/428,270, filed Apr. 22, 2009, and claims priority therefrom.

### TECHNICAL FIELD

This invention relates to a formulation that provides protection against forms of corrosion when in both the liquid and vapor phase.

### BACKGROUND

Combustion engines such as gasoline, diesel or gas engines, as well as the more modern fuel cell systems go through, following the production process, a “running-in” or “hot-test” phase prior to final parts assembly. This running-in phase varies in length from several minutes to a few hours, depending on the type of engine and the operation it will face later on. The “running-in” phase is used to guarantee the functionality of the engine or the system. Today's running-in fluids are quite diverse. They range from pure water over coolant to oil emulsions. Most demonstrate some sort of technical disadvantage.

When putting together the parts after the running-in phase, different means of operation can be used. In many cases, however, the engine builders centralize their production. Following initial testing parts may be shipped all over the world prior to being built into a final operating configuration. During this storage and transport time, the parts may come in contact with corrosive conditions. They require protection against the negative influences faced during storage and/or transport. For economical reasons, the running-in fluid is almost completely removed from the part prior to it going into storage.

This way of operation means that standard coolant formulations do not provide optimal protection to a part following the running-in phase, when it is being stored or transported. Most of the current formulations provide no sustained protection when not in direct contact with the surface they need to protect. Using a standard coolant formulation as hot test fluid is certainly viable in situations where the parts are directly built in after testing. In modern economic climates, however, this is seldom the case. Combined storage and transport time periods have been observed from 3 months to up to 9 months. What is needed is a formulation useful in protecting a part from corrosion following the “running-in” phase and prior to final installation.

In modern combustion engines in particular, thermal loads have high requirements with regard to the materials used. Any form of corrosion, even minor forms, results in a potential risk factor and can lead to a reduction of the lifetime of the engine and correspondingly, safe vehicle operation. In addition, the increased number of different metals and alloys used is increasing, making the system more susceptible to corrosion, particularly on those places where the different parts or alloys make direct or indirect contact with each other.

Most running-in fluids focus on the protection of ferrous alloys, since those alloys are particularly sensitive to general forms of corrosion. Engine blocks and engine liners typically require ferrous corrosion protection during transport or storage. In addition, the formed corrosion products are very visible and dissolve easily in the cooling system. Once the corrosion products are released from the corroded surface they can be transported and create other issues like blockages, galvanic corrosion or problems related to heat transfer. In engine construction, the trend towards lighter alloys like aluminum for the water pump or even the engine head is apparent. Since, in current engine design, multiple parts are pre-assembled together, the need for a running-in fluid that protects all metals and not solely ferrous alloys is a must.

Oil emulsions can provide protection to parts for a fuel cell system in transit. There are some incompatibility issues which occur when the coolant is added, however. Although the soluble oil provides some residual corrosion protection, it will decrease the heat transfer in engine or fuel cell system by forming a heat isolating, although protective layer. Because efficient heat removal is essential, certainly in the more powerful engines that comply with the more modern environmental legislation, the running-in fluid should not negatively affect the heat transfer from the parts into the cooling system.

Coolants are necessary to remove heat from the engine. To give the engine optimal efficiency, the excess heat must be removed as fast as possible without damaging or decreasing the operation of all cooling system parts. Much work and effort has been expended for the protection of the cooling system materials, especially towards the protection against corrosion at high temperatures. Although from a corrosion standpoint high temperatures can be damaging, there can also be issues at low temperatures during engine operation. At low temperatures, solubility and pumpability can be of concern.

Ideally the coolant remains transparent and free of insolubles. Haziness, precipitation or, in extremes, gel formation are considered detrimental for the performance of an engine coolant. Problems resulting from instability can be seen in damage to water pump seals, engine head seals, hoses or any other parts where softer materials are in use. Gel formation, on the other hand, negatively impacts viscosity, resulting in a decrease in the heat transfer characteristics of the fluid. Heat transfer capability is the main requirement of a coolant fluid. Because the risk for coolant instability is maximized at low temperatures, most problems occur under cold start conditions.

Many antifreeze compositions are known which may contain a variety of ingredients. U.S. Pat. No. 6,802,988, for example discloses an antifreeze concentrate which comprises alkylene glycol in combination with a mixture of at least two dicarboxylic acids or their salts, alkali metal or ammonium molybdates, as well as triazole or thiazole corrosion inhibitors.

U.S. 2002/0030177 A1 discloses a glycol based additive for corrosion prevention further comprising carboxylie acid, azoles, molybdates, polyvinyl, pyrrolidone and a nitrite salt.

### SUMMARY OF THE INVENTION

The stability effect of organic acids in synergistic combination with an inorganic ammonium salt and silicate, as demonstrated in this invention, is novel. This formulation not only provides excellent protection for liquid and vapor corrosion on ferrous liner alloys such as used in cylinder liners and engine blocks) but in addition provides excellent corrosion protection from aluminum alloys such as those in engine heads.

Water is the preferred solvent in this invention, due to its toxicological benefits in comparison with the glycols. Many patents describe explicitly the use of freezing point depressants when trying to provide vapor phase protection after running-in cycle. The current invention provides sufficient protection in the vapor phase as well as in the liquid phase, even without the addition of a freezing point depressant. In case freezing point depressant is needed it can, of course, be added and an even improved performance will be noticeable.

### DETAILED DESCRIPTION OF THE INVENTION

The instant invention preferably employs water as solvent, and combines the positive characteristics from both coolants and oil emulsions. It has the excellent compatibility with coolants added subsequently, and does not negatively affect heat transfer characteristics, as would an oil emulsion. It also provides sustainable corrosion protection during the running-in period as well as during subsequent storage, when most of the product has been drained. Best results are observed when the part is sealed or air flow is not completely free. This allows the additives to come to equilibrium and condition the atmosphere so corrosion protection is guaranteed during storage or transport.

One embodiment of the invention may be a concentrate used to prepare a running-in or hot test fluid. It may be diluted as a second embodiment. Alternatively also a freezing protection base fluid like an alcohol or short chain organic acid can be added for those situations where freezing protection would be needed during storage or transport.

The addition of a liquid with increased viscosity relative to water to provide freeze protection further improves the protection level during storage and or transport. As those freezing depressant fluids have a higher viscosity and are considered to be slippery, they are not preferred unless freeze protection is really needed. Freezing point depressant may be present in the range from 10 to 60 vol %, preferably in the range from 30 to 50 vol %. A liquid alcohol or organic salt freezing point depressant component can be added to provide freezing protection. The freezing point depressant can contain polyalcohols such as ethylene glycol, di-ethylene glycol, propylene glycol, di-propylene glycol, glycerin and glycol monoethers such as the methyl, ethyl, propyl and butyl ethers of ethylene glycol, di-ethylene glycol, propylene glycol and di-propylene glycol. Ethylene and propylene glycol are particularly preferred as the freezing point depressant component. Non-limiting examples of organic acid salt as freezing point depressant inclide esters of carbrexylic acids, including formiate, acetate, propionate, adipate or succinate or combinations thereof.

Alternatively additional coolant additives such as silicates, nitrites, nitrates, phosphates, molybdates, anti-oxidants, thiazole derivatives, triazoles, polyacrylates, phosphonates and borates can be used to provide protection in the water phase.

Examples of optional additional coolant are the typical coolant additives. These include but are not limited to silicates, nitrites, nitrates, phosphates, molybdates, anti-oxidants, thiazole derivatives, polyacrylates, phosphonates and borates that can be used to provide protection in the water phase.

### EXAMPLES

### Example 1

### Comparative Example

A running fluid was prepared comprising a major amount of water, 1.5 weight percent isononanoic acid, 0.95 weight percent benzoic acid, 0.1 weight percent triazole, 0.1 weight percent ammonium bicarbonate and brought to a pH of 8.9.

### Example 2

### Comparative Example

A running fluid was prepared comprising a major amount of water, 1.5 weight percent isononanoic acid, 0.95 weight percent benzoic acid, 0.1 weight percent triazole, 0.17 weight percent ammonium bicarbonate and brought to a pH of 8.9.

### Example 3

### Comparative Example

A running fluid was prepared comprising a major amount of water, 1.5 weight percent isononanoic acid, 0.95 weight percent benzoic acid, 0.1 weight percent triazole, 0.04 weight percent ammonium bicarbonate, 0.07 weight percent sodium metasilicate pentahydrate, 0.14 weight percent silicate stabilizer and brought to a pH of 8.9.

### Example 4

### Example of the Invention

A running fluid was prepared comprising a major amount of water, 1.5 weight percent isononanoic acid, 0.95 weight percent benzoic acid, 0.1 weight percent triazole, 0.13 weight percent ammonium bicarbonate, 0.07 weight percent sodium metasilicate pentahydrate 0.14 weight percent silicate stabilizer and brought to a pH of 8.9.

### Example 5

### Example of the Invention

A running fluid was prepared comprising a major amount of water, 1.5 weight percent isononanoic acid, 0.95 weight percent benzoic acid, 0.1 weight percent triazole, 0.02 weight percent ammonium bicarbonate, 0.07 weight percent sodium metasilicate pentahydrate 0.14 weight percent silicate stabilizer and brought to a pH of 8.9.

### Example 6

### Comparative Example

A running fluid was prepared comprising a major amount of water, 1.5 weight percent isononanoic acid, 0.95 weight percent benzoic acid, 0.1 weight percent triazole, 0.07 weight percent ammonium bicarbonate, 0.07 weight percent sodium metasilicate pentahydrate 0.14 weight percent silicate stabilizer and brought to a pH of 8.9.

### Example 7

### Example of the Invention

A running fluid was prepared comprising a major amount of water, 1.5 weight percent isononanoic acid, 0.95 weight percent benzoic acid, 0.1 weight percent triazole, 1.0 weight percent ammonium bicarbonate, 0.07 weight percent sodium metasilicate pentahydrate 0.14 weight percent silicate stabilizer and brought to a pH of 8.9.

### Example 8

### Example of the Invention

A running fluid was prepared comprising a major amount of water, 1.5 weight percent isononanoic acid, 0.95 weight percent benzoic acid, 0.1 weight percent triazole, 5.0 weight percent ammonium bicarbonate, 0.07 weight percent sodium metasilicate pentahydrate 0.14 weight percent silicate stabilizer and brought to a pH of 8.9.

### Example 9

### Comparative Example

A running fluid was prepared comprising a major amount of water, 1.5 weight percent isononanoic acid, 0.95 weight percent benzoic acid, 0.1 weight percent triazole, 0.12 weight percent ammonium bicarbonate, 0.07 weight percent sodium metasilicate pentahydrate 0.14 weight percent silicate stabilizer and brought to a pH of 6.0.

### Example 10

### Comparative Example

A running fluid was prepared comprising a major amount of water, 1.5 weight percent isononanoic acid, 0.95 weight percent benzoic acid, 0.1 weight percent triazole, 0.12 weight percent ammonium bicarbonate, 0.07 weight percent sodium metasilicate pentahydrate 0.14 weight percent silicate stabilizer and brought to a pH of 8.2.

### Example 11

### Example of the Invention

A running fluid was prepared comprising a major amount of water, 1.5 weight percent isononanoic acid, 0.95 weight percent benzoic acid, 0.1 weight percent triazole, 0.12 weight percent ammonium bicarbonate, 0.07 weight percent sodium metasilicate pentahydrate 0.14 weight percent silicate stabilizer and brought to a pH of 9.7.

### Example 12

### Example of the Invention

A running fluid was prepared comprising a major amount of water, 1.5 weight percent isononanoic acid, 0.95 weight percent benzoic acid, 0.1 weight percent triazole, 0.12 weight percent ammonium bicarbonate, 0.07 weight percent sodium metasilicate pentahydrate 0.14 weight percent silicate stabilizer and brought to a pH of 12.0.

### Example 13

### Prior Art Example

A concentrate containing: 3 w % 2-ethylhexanoic acid; 0.175 w % Sodium nitrate; 0.45 w % Sodium nitrite; 0.6 w % stabilized silicate; 0.25 w % tolyltriazole; 0.3 w % polyvinylpyrolidone (15%); 0.03 w % defoamer; 0.05 w % ammonium molybdate; potassium hydroxide (45 w %) as pH controlling set to pH at 8.7 and rest monoethylene glycol. This concentrate is diluted with two volume of water before testing.

### Example 14

### Prior Art Example

A concentrate containing: 1.75 w % succinic acid; 1.75 w % sebacic acid; 0.3 w % ammonium molybdate; 0.15 w % tolyltriazole; 0.15 w % benzotriazole; 0.6 w % benzoic acid; 1 w % water sodium hydroxide (50 w %) as pH controlling set to pH at 8.2 and rest monoethylene glycol. This concentrate is diluted 40 vol % with water before testing.

### Test Method

Since this invention seeks to protect different metals from corrosion, a selection of several metals was performed and a test bundle made up of Copper, Cast iron 1 (engine block alloy), Cast iron 2 (cover alloy), Cast Iron 3 (liner alloy), and aluminum was used. Aluminum alloys as well as ferrous alloys were selected as the subject metals.

All pieces are handled in an identical way as in ASTM D-1384, (standard test method for corrosion test for engine coolants in glassware) and assembled as follows:

From left to right:
Teflon leg/Brass spacer/Teflon small ring/COPPER/Brass ring/Teflon small ring/CAST IRON 1/Steel Spacer/Steel spacer/CAST IRON 2/Steel Spacer/CAST IRON 3/Steel Spacer/Teflon small ring/ALUMINIUM/Brass spacer/Teflon leg

The metal bundle is placed in a glass vial and filled with running-in fluid. The vial is put in the oven and a temperature cycle is performed:

1 hour at 130° C. (air temperature)+30 min at 100° C. (air temperature)

Cool down for 8 hours

Remove half of the liquid so the metal bundle remains half submerged

The glass vial container with metal specimens is put back in the oven to follow the temperature cycle below:

8 hours at 23° C. (air temp)

8 hours at 40° C. (air temperature)

8 hours at 0° C.

This cycle is repeated for 7 days

After the temperature cycle is completed the metals specimens are examined and weight losses determined

Visual examination and amount of weight lost were the criteria employed below.

TABLE
Results

| | | | | Ex 4 | |
|---|---|---|---|---|---|
| | Ex 1 | Ex 2 | Ex 3 | (Example of | Ex 5 |
| | (Comparative) | (Comparative) | (Comparative) | invention) | (Comparative) |
| Visual liquid phase | Severe blackening | Severe blackening | No discoloration | No discoloration | No discoloration |
| Aluminum alloy | | | | | |
| Visual vapor phase | Severe blackening | Severe blackening | No discoloration | No discoloration | No discoloration |
| Aluminum alloy | | | | | |
| Weight loss aluminum | 15 mg | 17 mg | 0 mg | 0 mg | 0 mg |
| alloy | | | | | |
| Visual liquid phase | Slightly stained | Slightly stained | Slightly stained | Slightly stained | Slightly stained |
| Ferrous alloy | | | | | |
| Visual vapor phase | Slightly stained | Slightly stained | Severely corroded | Slightly stained | Severely corroded |
| Ferrous alloy | | | | | |
| Weight loss Ferrous | 5 mg | 2 mg | 41 mg | 1 mg | 25 mg |
| alloy* | | | | | |
| | | Ex 7 | Ex 8 | | |
| | Ex 6 | (Example of | ( )Example of | Ex 9 | Ex 10 |
| | (Comparative) | invention) | invention | (Comparative) | (Comparative) |
| Visual liquid phase | No discoloration | No discoloration | No discoloration | Severe blackening | No discoloration |
| Aluminum alloy | | | | | |
| Visual vapor phase | No discoloration | No discoloration | No discoloration | No discoloration | No discoloration |
| Aluminum alloy | | | | | |
| Weight loss aluminum | 0 mg | 0 mg | 0 mg | 1 mg | 0 mg |
| alloy | | | | | |
| Visual liquid phase | Slightly stained | Slightly stained | Slightly stained | Severely corroded | Slightly stained |
| Ferrous alloy | | | | | |
| Visual vapor phase | Slightly corroded | Slightly stained | Slightly stained | Severely corroded | Severely corroded |
| Ferrous alloy | | | | | |
| Weight loss Ferrous | 6 mg | 1 mg | 1 mg | 31 mg | 16 mg |
| alloy* | | | | | |

| | Ex 11 | Ex 12 | Ex 13 | Ex 14 |
|---|---|---|---|---|
| | (Example of | (Example of | (Prior art | (Prior art |
| | invention) | invention) | example) | example) |
| Visual liquid phase | No discoloration | No discoloration | No discoloration | Some blackening |
| Aluminum alloy | | | | |
| Visual vapor phase | No discoloration | No discoloration | No discoloration | Some blackening |
| Aluminum alloy | | | | |
| Weight loss aluminum | 0 mg | 1 mg | 0 mg | 1 mg |
| alloy | | | | |
| Visual liquid phase | Slightly stained | Slightly stained | Slightly stained | Slightly stained |
| Ferrous alloy | | | | |
| Visual vapor phase | Slightly stained | Slightly stained | Slightly corroded | Slightly corroded |
| Ferrous alloy | | | | |
| Weight loss Ferrous | 2 mg | 2 mg | 7 mg | 9 mg |
| alloy* | | | | |

Legend
1 Visual examination—Levals
No discoloration—best
Slightly stained
Severe blackening
Slightly corroded
Severely corroded—worst
2 Weight loss—The greater the alloy weight loss the less protection provided

It is apparent from the data of the Table that corrosion protection was superior, in both the liquid phase and vapor phase, when using the solutions of the inventions as opposed to the solutions of the Comparative Examples or Prior Art examples. No corrosion was demonstrated on. Ferrous alloys or aluminum alloys in the invention examples in either the liquid or vapor phase.

We claim:

1. A concentrate for running-in fluid which provides anti-corrosion properties in both liquid and vapor phases, said concentrate comprising at least one inorganic ammonium compound present in a range from about 0.08 wt % about to 10 wt % in synergistic combination with at least one carboxylic acid present in an amount from above 0.01 wt % and a silicate present in a range from about 0.05 wt % to about 10 wt %.

2. The concentrate of claim 1, wherein the inorganic ammonium compound is selected from the group consisting of ammonium bicarbonate, ammonium biphosphate, ammonium molybdate, ammonium nitrate, ammonium sulfate, ammonium perchlorate, ammonium persulfate, and ammonium hydroxide.

3. The concentrate of claim 1, wherein the carboxylate acid is selected from the group consisting of monocarboxylic acids, dicarboxylic acid, aliphatic monocarboxylic acid, aliphatic dicarboxylic acid, branched carboxylic acid or aromatic unbranched and branched carboxylic acids.

4. The concentrate of claim 1, wherein the silicate is an inorganic alkali metal silicate.

5. A ready-to-use fluid which provides anti-corrosion properties in both the liquid and vapor phases, during the “running-in” phase of an engine, which comprises, in a minor amount, at least one inorganic ammonium compound present in a range from about 0.08 wt % to about 10 wt % in synergistic combination with at least one carboxylic acid present in an amount above about 0.01 wt % and a silicate, present in a range from about 0.05 wt % to 10.0 wt % and further comprising, in a major amount from 50 wt % to 95 wt %, solvent.

6. The fluid of claim 5, wherein the inorganic ammonium compound is present in an amount below from about 0.05 wt % to about 5 wt %.

7. The fluid of claim 6, wherein the inorganic ammonium is present in an amount in the range from 0.05 wt % to 2 wt %.

8. The fluid of claim 5, wherein carboxylic acid is present in an amount from about 0.01 wt % to about 15 wt %.

9. The fluid of claim 8, wherein the carboxylic acid is present in an amount in the range from about 0.01 wt % to about 5 wt %.

10. The fluid of claim 5, having a pH in the range of about 8.0 to about 11.0.

11. The fluid of claim 10, having a pH in the range from about 8.5 to about 9.5.

12. The fluid of claim 5, which further comprises, in a minor amount, a freezing point depressant.

13. The fluid of claim 5, wherein the silicate is an inorganic alkali metal silicate.

14. The fluid of claim 14, wherein the inorganic alkali metal silicate is present in an amount from about 0.05 wt % to about 1 wt %.

15. The fluid of claim 14, wherein the inorganic alkali metal silicate is present in the range from 0.001 to 0.5 wt %.

16. The fluid of claim 14, wherein the solvent is water.

17. The fluid of claim 16, wherein the freezing point depressant is a liquid alcohol or organic salt.

18. The fluid of claim 16, wherein the liquid alcohol is a poly alcohol.

19. The fluid of claim 16, wherein the organic salt is selected from the group consisting of formiate, acetate, proprionate, adipate, succinate, or combination thereof.

20. The fluid of claim 5, which further comprises at least one coolant additive selected from the group consisting of silicates, nitrites, nitrates, phospites, molybdates, anti-oxidants, thiazole derivatives, triazole, polyacrylates, phosphonates and borates.
